(19) United States
(12) Patent Application Publication
(10) Pub. No.: US 2023/0090098 A1
(43) Pub. Date: Mar. 23, 2023

(54) FUNCTIONALISATION OF 1,3-ALPHA-DIENES (I)

(71) Applicant: DSM IP Assets B.V., HEERLEN (NL)

(72) Inventors: Werner BONRATH, Kaiseraugst (CH); Marc-André MUELLER, Kaiseraugst (CH); Bettina WUESTENBERG, Kaiseraugst (CH)

(21) Appl. No.: 17/787,806

(22) PCT Filed: Dec. 15, 2020
(86) PCT No.: PCT/EP2020/086174

§ 371 Date: Jun. 21, 2022

(30) Foreign Application Priority Data
Dec. 23, 2019 (EP) 19219366.2

(51) Int. Cl. C07F 7/18

(52) U.S. Cl. CPC C07F 7/1876; C07F 7/1804

(57) ABSTRACT

The present invention relates to the functionalisation of specific 1,3-alpha-dienes. These functionalized 1,3-alpha-dienes are important intermediates in organic synthe-sis (especially in the synthesis of carotenoids, vitamin A and/or vitamin A derivatives).

The present invention relates to the functionalisation of specific 1,3-alpha-dienes. These functionalized 1,3-alpha-dienes are important intermediates in organic synthesis (especially in the synthesis of carotenoids, vitamin A and/or vitamin A derivatives).

The present invention relates to the functionalisation of specific 1,3-alpha-dienes by hydrosilylation followed by an oxidation to the corresponding alcohols.

The first step of the functionalization is a hydrosilylation process. The surprising effect of the present hydrosilylation is that it is the 1,4-addition product is obtained in majority. The 1,2-addition product is obtained in minor amounts only.

Hydrosilylation is a well-known reaction. The hydrosilylation of similar compounds (as the ones we claim and describe in the present patent application) are known from the prior art (i.e. from I. Ojima et al, Journal of Organometallic Chemistry 1978, 157(3), 359-372).

In all hydrosilylations of similar compounds known from the prior art, the 1,2 addition is the major product. In the reactions disclosed by (I. Ojima et al, Journal of Organometallic Chemistry 1978, 157(3), 359-37), the ratio of 1,2-addition product to 1,4-addition product is always at least 3:1.

The 1,4-addition product is a very interesting intermediate in the organic synthesis, especially in the synthesis of carotenoids, vitamin A and vitamin A derivatives.

Therefore, there is a need for a hydrosilylation process, which allows to produce the 1,4-adduct in major amounts and where also the overall yield is excellent. Therefore, the present invention relates to a hydrosilylation process (P), wherein a compound of formula (I)

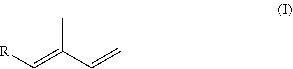

wherein R is

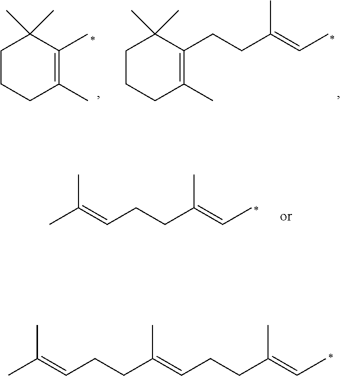

(wherein the asterix shows the connecting bond) is reacting with a compound of formula (II)

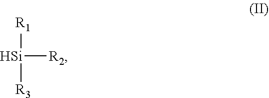

wherein

R₁ is —CH₃, —CH₂CH₃, —(OCH₂CH₃) or phenyl,

R₂ is —CH₃, —CH₂CH₃ or —(OCH₂CH₃),

R₃ is —CH₃, —CH₂CH₃ or —(OCH₂CH₃), in the presence of at least one transition metal catalyst.

The hydrosilylation can be carried out with or without any solvent. In case a solvent is used, the solvent needs to be inert.

Preferably, the hydrosilylation is carried out without any solvent.

Therefore, the present invention also relates to a hydrosilylation process (P1), which is the hydrosilylation process (P), wherein the process is carried out in an inert solvent.

Therefore, the present invention also relates to a hydrosilylation process (P2), which is the hydrosilylation process (P), wherein the process is carried out without any solvent.

Preferred is a process wherein the compound of formula (Ia)

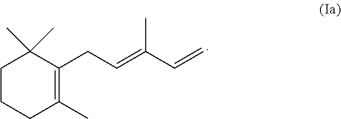

is used as starting material.

Also preferred is a process wherein the compound of formula (Ib)

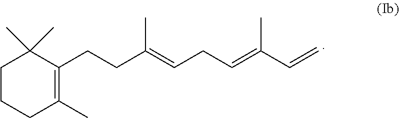 [SMILES: C=C/C(C)=C/C/C=C(\C)CCC1=C(C)CCCC1(C)C]

is used as starting material.

Also preferred is a process wherein the compound of formula (Ic)

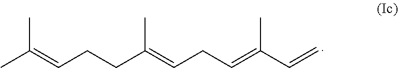

is used as starting material.

Also preferred is a process wherein the compound of formula (Id)

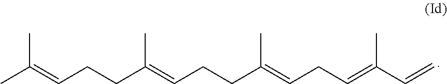 [SMILES: C=C/C(C)=C/C/C=C(\C)CC/C=C(\C)CCC=C(C)C]

is used as starting material.

Therefore, the present invention also relates to a hydrosilylation process (P3), which is the hydrosilylation process (P), (P1) or (P2), wherein the compound of formula (Ia)

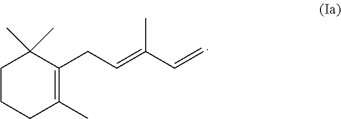

is used as starting material.

Therefore, the present invention also relates to a hydrosilylation process (P3′), which is the hydrosilylation process (P), (P1) or (P2), wherein the compound of formula (Ib)

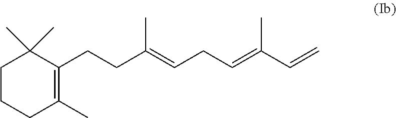 [SMILES: C=C/C(C)=C/C/C=C(\C)CCC1=C(C)CCCC1(C)C]

is used as starting material.

Therefore, the present invention also relates to a hydrosilylation process (P3″), which is the hydrosilylation process (P), (P1) or (P2), wherein the compound of formula (Ic)

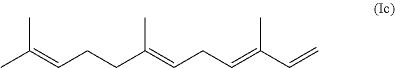

is used as starting material.

Therefore, the present invention also relates to a hydrosilylation process (P3″), which is the hydrosilylation process (P), (P1) or (P2), wherein the compound of formula (Id)

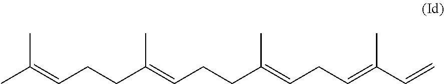 [SMILES: C=C/C(C)=C/C/C=C(\C)CC/C=C(\C)CCC=C(C)C]

is used as starting material.

Furthermore, the compound of formula (Ib)

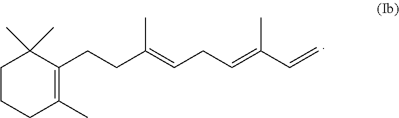 [SMILES: C=C/C(C)=C/C/C=C(\C)CCC1=C(C)CCCC1(C)C]

is new.

Therefore, the present invention also relates to the compound of formula (Ib)

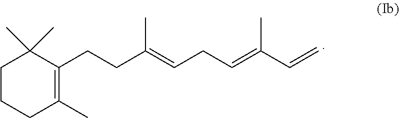 [SMILES: C=C/C(C)=C/C/C=C(\C)CCC1=C(C)CCCC1(C)C]

A way to obtain the compound (Ib) in a good yield is the following:

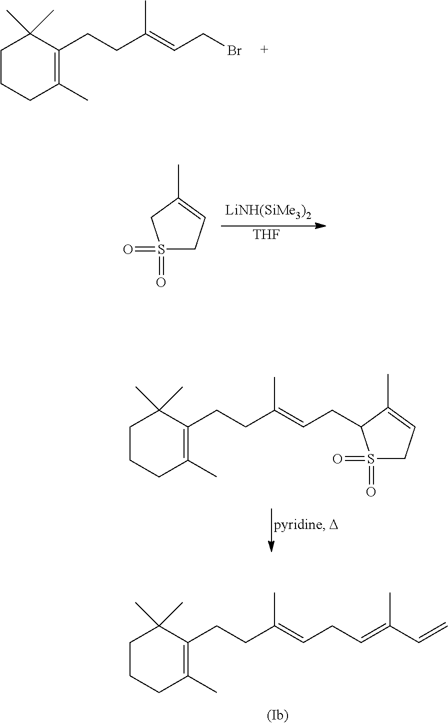

Preferred is a process, wherein the compound of formula (IIa)

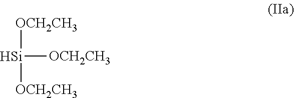

is used as the hydrosilylation reactant.

Therefore, the present invention also relates to a hydrosilylation process (P4), which is the hydrosilylation process (P), (P1), (P2), (P3), (P3′), (P3″) or (P3″), wherein the compound of formula (IIa)

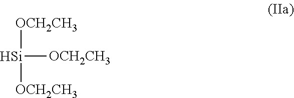

is used as the hydrosilylation reagent.

The compound of formula (II) is added to the reaction mixture usually in an equimolar amount in regard to the compound of formula (I). It is possible to add a slight excess of the compound of formula (II) in regard to the compound of formula (I). Preferred is an equimolar amount.

Therefore the present invention also relates to a hydrosilylation process (P5), which is the hydrosilylation process (P), (P1), (P2), (P3), (P3′), (P3″), (P3″), or (P4), wherein the compound of formula (II) is added to the reaction mixture in an equimolar amount in regard to the compound of formula (I).

The process according to the present invention is carried out in the presence of at least one transition metal catalyst, preferably a Rh catalyst.

A very preferred catalyst is tris(triphenylphosphine)rhodium(I) chloride.

Therefore, the present invention also relates to a hydrosilylation process (P6), which is the hydrosilylation process (P), (P1), (P2), (P3), (P3′), (P3″), (P3″), (P4) or (P5), wherein the catalyst is tris(triphenylphosphine)rhodium(I) chloride.

The catalyst is added in low amounts. An usual (and also preferred range is 0.01-0.5 mol-% in view of the compound of formula (I). More preferred is a range of is 0.05-0.3 mol-% in view of the compound of formula (I).

Therefore the present invention also relates to a hydrosilylation process (P7), which is the hydrosilylation process (P), (P1), (P2), (P3), (P3′), (P3″), (P3″), (P4), (P5) or (P6), wherein the catalyst used in an amount of 0.01-0.5 mol-% in view of the compound of formula (I). (More preferred is a range of is 0.05-0.3 mol-% in view of the compound of formula (I).

The hydrosilylation reaction is usually carried out at temperature range of from 25° C.-100° C. Preferred are elevated temperatures (from 30° C. to 100° C.).

Therefore the present invention also relates to a hydrosilylation process (P8), which is the hydrosilylation process (P), (P1), (P2), (P3), (P3′), (P3″), (P3″), (P4), (P5), (P6) or (P7), wherein the process is carried out at temperature range of from 25° C.-100° C.

Therefore the present invention also relates to a hydrosilylation process (P8′), which is the hydrosilylation process (P8), wherein the process is carried out at temperature range of from 30° C. to 100° C.

Furthermore, the hydrosilylation reaction can be carried out under an inert gas atmosphere (usually N₂ gas).

Therefore the present invention also relates to a hydrosilylation process (P9), which is the hydrosilylation process (P), (P1), (P2), (P3), (P3′), (P3″), (P3′″), (P4), (P5), (P6), (P7), (P8) or (P8′), wherein the process is carried out under an inert gas atmosphere (usually N₂ gas).

Furthermore, some of the obtained reaction products (compounds of formula (III) and (III′)) from the hydrosilylation process are new compounds.

The following compounds (of formula (IIIa), (IIIb), (IIIc), (III′a), (III′b) and (III′c)) are new:

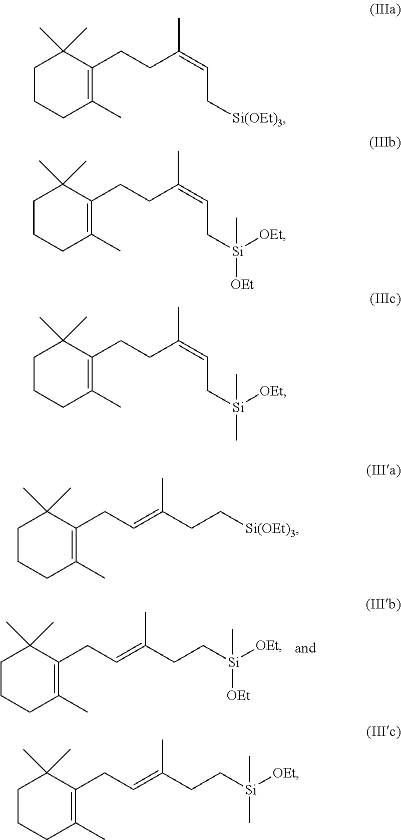

Therefore a further embodiment of the present invention are the compounds of formula (IIIa), (IIIb), (IIIc), (III′a), (III′b) and (III′c):

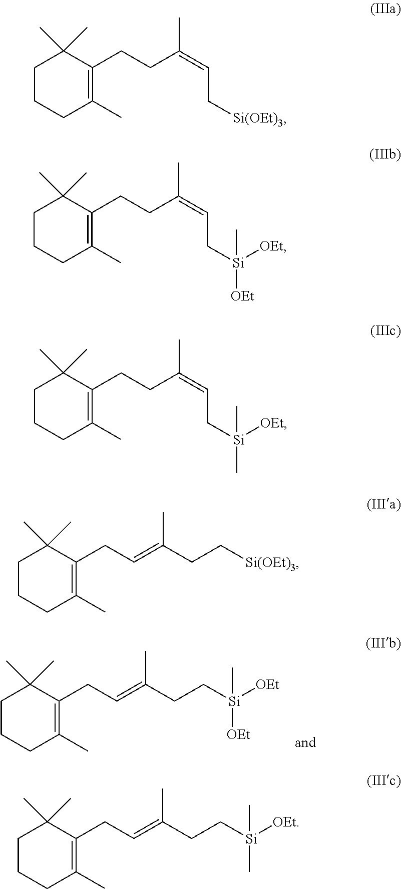

Furthermore, the following compounds of formula (IIId), (IIIe), (IIIf), (IIId′), (III′e) and (III′f) are new:

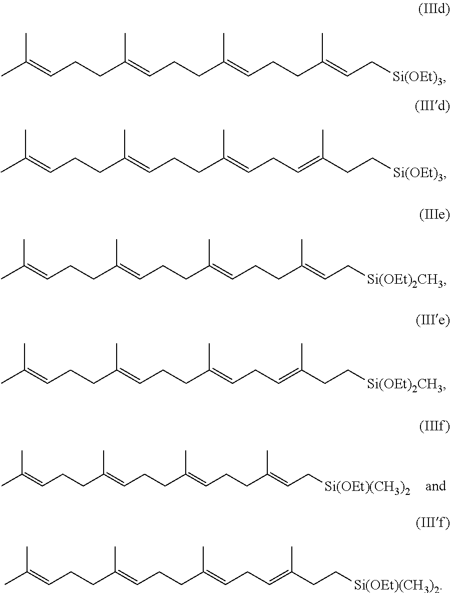

It is clear that the compounds of formula (IIId), (IIIe), (IIIf), (IIId′), (III′e) and (III′f) can be in any E/Z isomeric form.

Therefore a further embodiment of the present invention are the compounds of formula (IIId), (IIIe), (IIIf), (IIId′), (III′e) and (III′f)

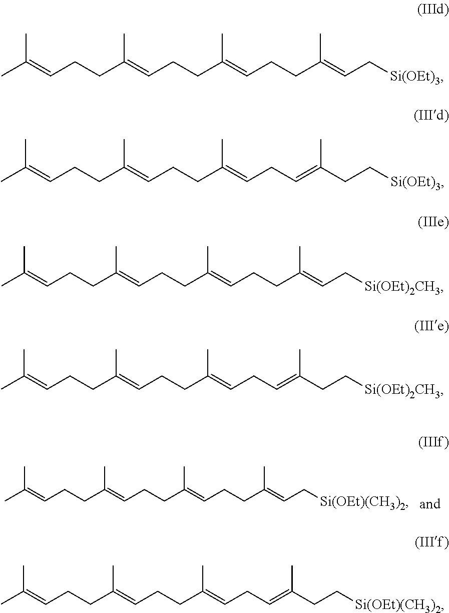

The starting material—the compounds of formula (I)— (if not commercially available) can be produce by commonly known method (i.e. Desai, Shailesh R. et al., Tetrahedron 1992, 48(3), 481-490.

To obtain the intermediates, which are very suitable in the organic synthesis (especially in the production of carotenoids, vitamin A and vitamin A derivatives, the reaction products of the hydrosilylation process (the compounds of formula (III) and (III′)) are converted into alcohols via an oxidative cleavage as shown in the following scheme

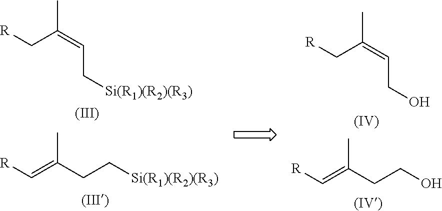

The oxidative cleavage is carried according to well-known processes. Usually and preferably the oxidative cleavage is carried in the presence of hydrogen peroxide and a base.

The following example illustrate the invention. All parts are related to weight and the temperatures are given in ° C.

### EXAMPLES

### Example 1

In a 5 ml flask under inert gas atmosphere were added subsequently cyclo-alpha-farnesene (compound of formula (Ia)) (1.00 g, 4.08 mmol), triethoxysilane (0.758 ml, 4.08 mmol) and tris(triphenylphosphine)rhodium(I) chloride (3.78 mg, 4.08 μmol, 0.1 mol %). The mixture was warmed to 65° C. in an oil-bath and stirred for 24 hours. After that the oil-bath was removed, and the reaction mixture was allowed to cool to room temperature. Without further work-up, the crude product was obtained as a mixture of 1,4-addition and 1,2-addition products (compounds of formula (IIIa) and (III′a)) (1.64 g, 64.4% purity by qNMR, 84% yield, 2a/3a=83:17) and was purified by column chromatography (SiO₂, cyclohexane/diisopropyl ether 9:1).

### Example 2

In a 5 ml flask under inert gas atmosphere were added subsequently cyclo-alpha-farnesene (compound of formula (Ia)) (1.00 g, 4.08 mmol), diethoxymethylsilane (0.653 ml, 4.08 mmol) and tris(triphenyl-phosphine)rhodium(I) chloride (3.78 mg, 4.08 μmol, 0.1 mol %). The mixture was warmed to 65° C. in an oil-bath and stirred for 21.5 hours. After that the oil-bath was removed, and the reaction mixture was allowed to cool to room temperature. Without further work-up, the crude product was obtained as a mixture of 1,4-addition and 1,2-addition products (compounds of formula (IIIb) and (III′b)) (1.50 g, 78.2% purity by qNMR, 85% yield, 2b/3b=46:54) and was purified by column chromatography (SiO₂, cyclohexane/diisopropyl ether 9:1).

### Example 3

In a 5 ml flask under inert gas atmosphere were added subsequently cyclo-alpha-farnesene (compound of formula (Ia)) (1.00 g, 4.16 mmol), dimethylethoxysilane (0.610 ml, 4.16 mmol) and tris(triphenylphosphine)rhodium(I) chloride (3.85 mg, 4.16 μmol, 0.1 mol %). The mixture was warmed to 65° C. in an oil-bath and stirred for 16 hours. After that the oil-bath was removed, and the re-action mixture was allowed to cool to room temperature. Without further work-up, the crude product was obtained as a mixture of 1,4-addition and 1,2-addition products (compounds of formula (IIIc) and (III′c)) (1.43 g, 77% purity by qNMR, 86% yield, 2c/3c=33:67) and was purified by column chromatog-raphy (SiO₂, cyclohexane/diisopropyl ether 95:5).

### Example 4

In a 5 ml flask under inert gas atmosphere were added subsequently alpha-farnesene (Compound of formula (Ic)) (0.75 g, 99.4%, 3.65 mmol), diethoxymethylsilane (0.584 ml, 3.62 mmol) and tris(triphenylphosphine)rhodium(I) chloride (3.38 mg, 3.65 μmop. The mixture was warmed to 65° C. in an oil-bath and stirred for 23 hours. After that the oil-bath was removed, and the reaction mixture was allowed to cool to room temperature. Without further work-up, the crude product was obtained as a mixture of 1,4-addition and 1,2-addition products of the following formula

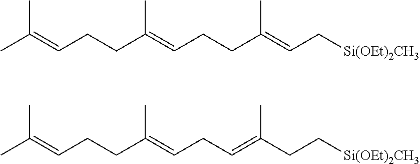

(1.19 g, 79.3% purity by qNMR, 76% yield, (IIId)/(III′d)=84:16 [(IIId)/(III′d) ratio determined by GC/MS area %!]) and was purified by column chromatography (SiO₂, cyclohexane/diisopropyl ether 95:5).

### Example 5

In a 5 ml flask under inert gas atmosphere were added subsequently alpha-springene (Compound of formula (Id)) (0.300 g, 83.1%, 0.915 mmol), triethoxysilane (0.179 ml, 0.915 mmol) and tris(triphenylphosphine)rhodium(I) chloride (4.23 mg, 4.57 μmop. The mixture was warmed to 65° C. in an oil-bath and stirred for 4 hours. After that the oil-bath was removed, and the reaction mixture was allowed to cool to room temperature. The crude product was obtained as pale brown liquid and analysed without further work-up (490.7 mg, 75.7% purity by qNMR, 93% yield, (by GC/MS mainly 1,4-addition product).

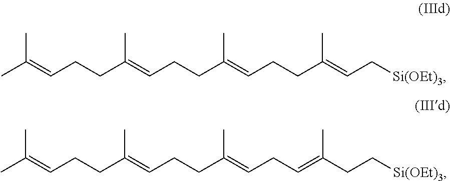

### Example 6 (Synthesis of the Compound of Formula (Ib)

Under inert gas atmosphere, 2,5-dihydro-3-methylthiophen-1,1-dioxid (8.68 g, 65.6 mmol) were dissolved in tetrahydrofuran (135 ml) and 1-(5-bromo-3-methyl-3-pentenyl)-2,6,6-trimethyl-cyclohexene (24.16 g, 65.6 mmol) were added. The brown solution was cooled to −78° C. At this temperature lithium bis(trimethylsilyl)amid was added dropwise over 50 min (exothermic reaction). After complete addition the reaction mixture was stirred for another 15 min at −78° C. Then, the reaction mixture was allowed to warm to 0° C., quenched with sat. aqueous ammonium chloride solution (90 ml) and stirred for 15 min. During this time a white precipitate formed which was dissolved by addition of water. The layers were separated, and the aqueous phase was extracted with THF (1×100 ml). The combined organic layers were filtered and concentrated under reduced pressure. The resulting orange suspension (26.6 g) was dissolved in heptane/ethyl acetate 95:5 v/v (60 ml) and purified by column chromatography (13.53 g, 61% yield).

The purified product (10.08 g, 30.0 mmol) was dissolved in pyridine (120 ml) and the yellow solution was heated to reflux (115° C.). After 3 hours the reaction mixture was cooled to room temperature and BHT (1 mg) was added. Then, pyridine was removed by distillation at 45° C. and 25 mbar (2 hours). The resulting residue was dissolved in heptane, filtered over silica (24 g of SiO₂, 7 ml of heptane) and concentrated under reduced pressure. The product (compound of formula (Ib)) was obtained as yellow liquid (7.46 g) in 87% yield (95.4% purity).

### Example 7

In a 5 ml flask under inert gas atmosphere were added subsequently alpha-diene (compound of formula (Ib)) (3.50 g, 95.4%, 12.25 mmol), triethoxysilane (2.394 ml, 12.25 mmol) and tris(triphenylphosphine)rhodium(I) chloride (11 mg, 12 μmol, 0.1 mol %). The mixture was warmed to 65° C. in an oil-bath and stirred for 5.5 hours. After that the oil-bath was removed, and the reaction mixture was allowed to cool to room temperature. Without further work-up, the crude product was obtained as a mixture of 1,4-addition and 1,2-addition products (

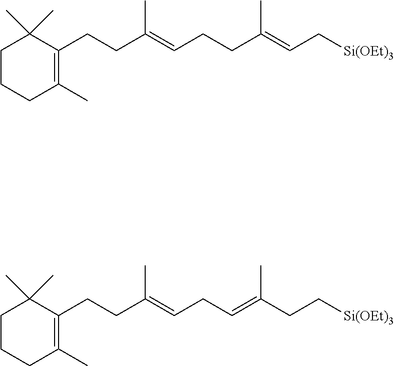

(5.44 g, 84.7% purity by qNMR, 86% yield, (IIIe)/(III′e)=90:10).

### Example 8

In a 5 ml flask under inert gas atmosphere were added subsequently alpha-diene (11) (500 mg, 95.4%, 1.751 mmol), diethoxymethylsilane (280 μl, 1.751 mmol) and tris(triphenylphosphine)rhodium(1) chloride (1.62 mg, 1.751 μmol, 0.1 mol %). The mixture was warmed to 65° C. in an oil-bath and stirred for 4.5 hours. After that the oil-bath was removed, and the reaction mixture was allowed to cool to room temperature. Without further work-up, the crude product was obtained as a mixture of 1,4-addition and 1,2-addition products

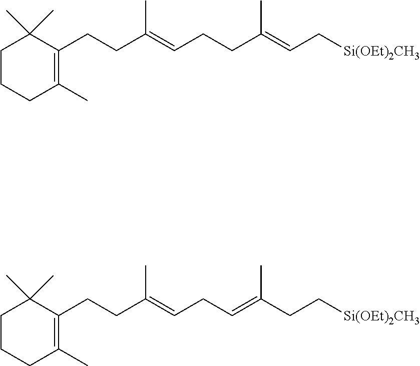

(714.6 mg, 75.6% purity by qNMR, 76% yield, (IIIf)/(III′f)=78:22).

### Example 9

In a 5 ml flask under inert gas atmosphere were added subsequently alpha-diene (500 mg, 95.4%, 1.751 mmol), dimethylethoxysilane (256 μl, 1.751 mmol) and tris(triphenylphosphine)rhodium(1) chloride (1.62 mg, 1.751 μmol, 0.1 mol %). The mixture was warmed to 65° C. in an oil-bath and stirred for 3 hours. After that the oil-bath was removed, and the reaction mixture was allowed to cool to room temperature. Without further work-up, the crude product was obtained as a mixture of 1,4-addition and 1,2-addition products

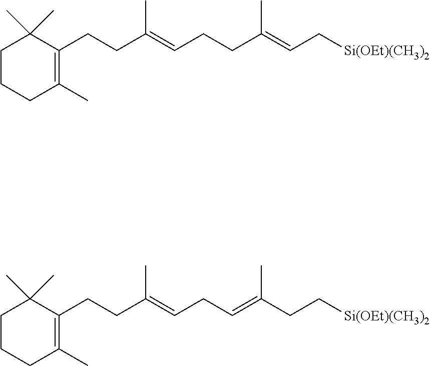

671.7 mg, 78.1% purity by qNMR, 80% yield, (IIIg)/(III′g)=77:23).

### Example 10

In a 25 ml flask under inert gas atmosphere, (E)-triethoxy(3-methyl-5-(2,6,6-trimethylcyclohex-1-en-1-yl)pent-2-en-1-yl)silane (500 mg, 1.276 mmol) was dissolved in THF (2.50 ml) and Methanol (2.500 ml). Potassium bicarbonate (128 mg, 1.276 mmol) and H₂O₂ (0.521 ml, 5.11 mmol) were added and the reaction mixture was heated to reflux. After 2 hours the reaction mixture was cooled to 0° C. A saturated solution of sodium bicarbonate (10 ml) was added, the mixture was diluted with diethyl ether (20 ml) and transferred to separation funnel. The layers were separated. The organic layer was washed with semi-saturated brine (2×20 ml) and the aqueous layers were re-extracted with diethyl ether (2×20 ml). The combined organic layers were dried over sodium sulfate and concentrated under reduced pressure (rotavap, 35° C.) affording 300 mg of crude product (77.8% purity by qNMR, 82% yield) as a mixture of regioisomers of the compound of formula (IVa) and (IV′a)

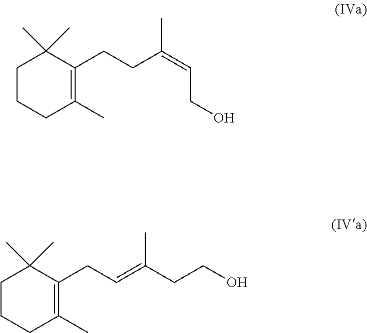 [SMILES: CC1=C(CC/C(C)=C\CO)C(C)(C)CCC1 ; CC1=C(C/C=C(\C)CCO)C(C)(C)CCC1]

in a ratio of 84:16 (IVa:(IV′a). The material was purified by column chromatography (SiO₂, cyclohexane/ethyl acetate 8:2).

### Example 11

In a 10 ml flask under inert gas atmosphere, (E)-diethoxy(methyl)(3-methyl-5-(2,6,6-trimethylcyclohex-1-en-1-yl)pent-2-en-1-yl)silane (300 mg, 0.811 mmol) was dissolved in THF (2.50 ml) and Methanol (2.500 ml). Potassium bicarbonate (81 mg, 0.811 mmol) and H₂O₂ (0.331 ml, 3.24 mmol) were added and the reaction mixture was heated to reflux. After 2.5 hours the reaction mixture was cooled to 0° C. A saturated solution of sodium bicarbonate (10 ml) was added, the mixture was diluted with diethyl ether (20 ml) and transferred to separation funnel. The layers were separated. The organic layer was washed with semi-saturated brine (2×20 ml) and the aqueous layers were re-extracted with diethyl ether (2×20 ml). The combined organic layers were dried over sodium sulfate and concentrated under reduced pressure (rotavap, 35° C.) affording 281 mg of crude product (63.3% purity by qNMR, 99% yield) as a mixture of regioisomers of the compound of formula (IVa) and (IV′a)

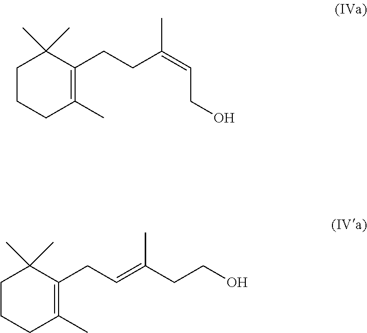 [SMILES: CC1=C(CC/C(C)=C\CO)C(C)(C)CCC1 ; CC1=C(C/C=C(\C)CCO)C(C)(C)CCC1]

in a ratio of 40:60(IVa:(IV′a). The material was purified by column chromatography (SiO₂, cyclohexane/ethyl acetate 8:2).

### Example 12

((2E,6E)-3,7-dimethyl-9-(2,6,6-trimethylcyclohex-1-en-1-yl)nona-2,6-dien-1-yl)triethoxysilane (5.39 g, 10.45 mmol) was dissolved in THF (35 ml) and methanol (35 ml). Potassium bicarbonate (1.046 g, 10.45 mmol) and hydrogen peroxide 30% (4.27 ml, 41.8 mmol were added and the mixture was heated to reflux. After 4.5 h the reaction mixture was cooled to 0° C. and saturated aqueous NaHCO₃-solution (100 ml) was added. The mixture was transferred into a separation funnel and diluted with diethyl ether (200 ml). The layers were separated, and the organic phase was washed with semi-saturated brine (2×200 ml). The aqueous layers were extracted with diethyl ether (2×200 ml). The combined organic layers were dried over sodium sulfate, filtered and concentrated under reduced pressure at 35° C. affording the crude product (3.76 g). The crude material was purified by column chromatography (SiO₂, cyclohexane/ethyl acetate 8:2). 2.23 g of product were obtained (88.3% purity by qNMR) as a mixture of regioisomers of formula (IVb) and (IV′b)

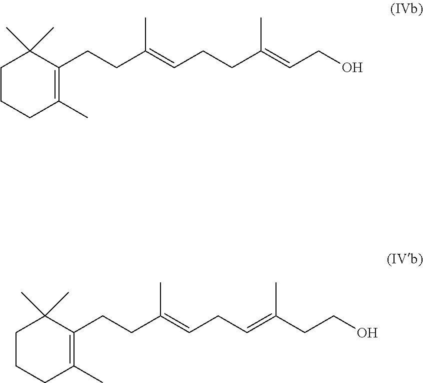 [SMILES: CC1=C(CC/C(C)=C/CC/C(C)=C/CO)C(C)(C)CCC1 ; CC1=C(CC/C(C)=C/C/C=C(\C)CCO)C(C)(C)CCC1]

1. A hydrosilylation process,
wherein a compound of formula (I) 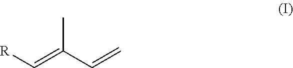
wherein R is 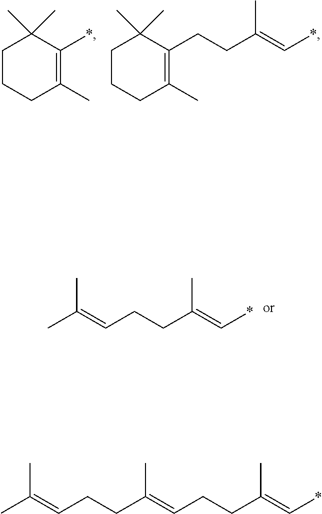
(wherein the asterix shows the connecting bond) is reacting with a compound of formula (II) 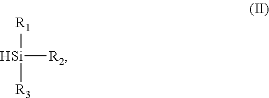
wherein
R₁ is —CH₃, —CH₂CH₃, —(OCH₂CH₃) or phenyl,
R₂ is —CH₃, —CH₂CH₃ or —(OCH₂CH₃),
R₃ is —CH₃, —CH₂CH₃ or —(OCH₂CH₃),
in the presence of at least one transition metal catalyst.

2. Process according to claim 1, wherein the process is carried out in an inert solvent.

3. Process according to claim 1, wherein the process is carried out without any solvent.

4. Process according to claim 1, wherein the compound of formula (Ia) 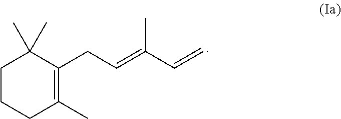
is used as starting material.

5. Process according to claim 1, wherein the compound of formula (Ib) 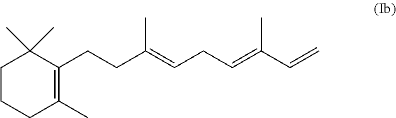 [SMILES: C=C/C(C)=C/C/C=C(\C)CCC1=C(C)CCCC1(C)C]
is used as starting material.

6. Process according to claim 1, wherein the compound of formula (Ic) 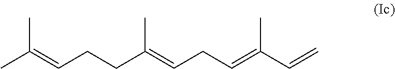
is used as starting material.

7. Process according to claim 1, wherein the compound of formula (Id) 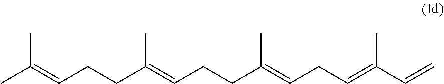 [SMILES: C=C/C(C)=C/C/C=C(\C)CC/C=C(\C)CCC=C(C)C]
is used as starting material.

8. Process according to claim 1, wherein the compound of formula (IIa) 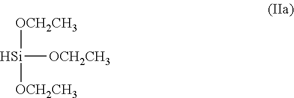
is used as the hydrosilylation reactant.

9. Process according to claim 1, wherein the compound of formula (II) is added to the reaction mixture in an equimolar amount in regard to the compound of formula (I).

10. Process according to claim 1, wherein the catalyst is tris(triphenylphosphine)rhodium(I) chloride.

11. Process according to claim 1, wherein the catalyst used in an amount of 0.01-0.5 mol-% in view of the compound of formula (I). (More preferred is a range of is 0.05-0.3 mol-% in view of the compound of formula (I).

12. Process according to claim 1, wherein the process is carried out at temperature range of from 25° C.-100° C.

13. Oxidative cleavage of the reaction product obtained by claim 1 carried out in the presence of hydrogen peroxide and a base.

14. Compounds of formula (IIIa), (IIIb), (IIIc), (III′a), (III′b) and (III′c)

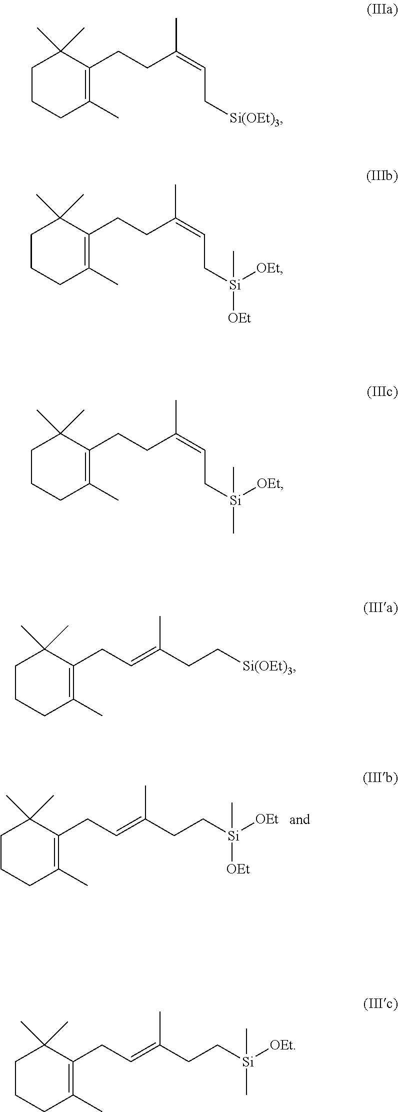

15. Compounds of formula (IIId), (IIIe), (IIIf), (IIId′), (III′e) and (III′f) [chemical structure]
